(19) United States
(12) Patent Application Publication
(10) Pub. No.: US 2026/0163956 A1
(43) Pub. Date: Jun. 11, 2026

(54) PERSONALIZED GENERATIVE MODEL CONDITIONING BASED ON USER INTERACTIONS

(71) Applicant: GOOGLE LLC, Mountain View, CA (US)

(72) Inventors: Carsten Isert, Zurich (CH); Patrick Andreas Zoechbauer, Zurich (CH)

(21) Appl. No.: 18/972,295

(22) Filed: Dec. 6, 2024

(51) Int. Cl. H04L 67/50; G06N 3/0475

(52) U.S. Cl. CPC H04L 67/535; G06N 3/0475

(57) ABSTRACT

Implementations described herein personalize a user's interactions with generative model(s), including through an automated assistant, by conditioning its queries and responses on user interactions with various computing devices and appliances over time. A first input prompt is assembled, including user-specific conditioning data built over time and new user interactions. This prompt is processed using generative models to identify outdated portions of the conditioning data. A second prompt is then assembled, including the identified outdated portions and the new interactions. This prompt is processed to generate new versions of the outdated portions. Finally, an updated user-specific conditioning data is stored for subsequent use, incorporating the new versions and unaltered portions of the user-specific conditioning data.

### BACKGROUND

Generative models such as single-modal or multi-modal large language models (LLMs) (e.g., vision language models or “VLMs”) can be used to process sequences of input tokens to generate sequences of output tokens. Generative models are applicable across a wide range of tasks. For example, generative models are increasingly being used to power automated assistants (also referred to as “virtual assistants” or “chatbots”), which enable humans (which are referred to as “users” when interacting with automated assistants) to participate in natural language dialogs with automated assistants. Some generative models that are pretrained/trained using web-scale data are referred to as “foundation” models. Recent iterations of generative models are able to process increasingly large amounts of data at once. Put another way, recent generative models have increasingly growing “context windows.”

### SUMMARY

When users engage with automated assistants, they may expect the automated assistants to “learn” from interactions with the user so that the automated assistants become increasingly personalized (or “bespoke”). For example, a vegetarian user may expect his or her automated assistant to learn—from an explicit input by the user and/or from observing various interaction(s) between the user and computing device(s) over time—that the user does not wish to receive restaurant recommendations for establishments with few or no vegetarian options.

As another example, users often use automated assistants to control smart appliances such as lights, thermostats, locks, media playback devices, etc. Those users may expect that as they make changes to their smart appliances—whether it be commissioning new appliances, altering existing appliances, or decommissioning existing appliances—the automated assistant will be made aware of those changes and respond to future requests appropriately. For example, if a user adds a smart light to a kitchen, the user may expect that future invocations of “turn on all the kitchen lights” will cause the new smart light to be turned on, too.

Some automated assistants may be personalized by building and maintaining a personalized user data structure, e.g., in the form of one or more database tables, a personalized knowledge graph, etc. Such a personalized user data structure may be updated manually by the user and/or automatically, e.g., when the user alters a smart appliance configuration, accepts or rejects a recommendation (e.g., of digital content, restaurant, etc.), engages in patterns of behavior (e.g., repeatedly eating the same type of cuisine), etc. However, conventional automated assistants may access personalized user data structures programmatically and/or using predefined actions, which can become unwieldy as the personalized data structure grows with increasingly heterogeneous data (e.g., emails, text messages, various user interactions with computing devices, etc.).

Implementations described herein relate to building and maintaining “user-specific conditioning data” (USCD) in association with individual users, as well as using USCD in conjunction with generative artificial intelligence (AI) to generate content that is tailored to individual users. The USCD may be built and/or maintained by accumulating data derived from various types of user interactions with computing devices. These user interactions can include, for instance, users sending/receiving electronic correspondence such as emails or texts, users reconfiguring smart appliances (e.g., lights, thermostats, locks, televisions, speakers, blinds, garage door openers, etc.), individuals submitting search queries and/or consuming content responsive to search queries, individuals' browsing data, individual engagement with social media, individual engagement with generative models (including any modality of data provided by the individual to the generative model, or generated using the generative model), individuals' consumption of documents and/or media (e.g., images, videos, games, podcasts, music, etc.), individuals' engagement with mapping applications (including accumulated locations, saves places, etc.), device and/or application configuration (e.g., applications installed on a mobile device, integration between applications, mobile device settings, etc.), data derived from documents created and/or edited using productivity software (e.g., word processing documents, spreadsheets, presentations), task lists, shopping lists, chats (e.g., SMS, MMS), reviews the individuals have posted (e.g., about restaurants, recipes, products), photos (including captions and/or detailed summaries of photos generated using generative models such as VLMs), payments made and/or received by individuals (including comments or metadata provided with those payments), third party software, personal uniform resource locators (URLs), and so forth.

While many examples described herein related to users interacting with generative model-powered automated assistants, this is not meant to be limiting. Techniques described herein are applicable outside of the automated assistant context. For example, techniques described herein may enable users of AI-powered productivity software, such as word processors, spreadsheets, presentation programs, etc., to have increasingly bespoke experiences. As another example, users engaging with a general-purpose generative model interaction interface (e.g., not specifically an automated assistant) such as might be provided via a web browser may benefit from techniques described herein.

As yet another example, an integrated development environment (IDE) or other application in which source code can be created/edited may include a generative AI assistant configured with selected aspects of the present disclosure. As yet another example, a robot that can be controlled using natural language may benefit from techniques described herein. Conditioning the robot's behavior on the individual's attributes and/or context represented by the individual's USCD may cause the robot to behave in a manner that is not only responsive to the individual's explicit command, but also is aware of the individual's personal preferences, context, attributes, etc. For example, if the individual asks the robot, “can you get me something to drink,” an underlying world model (implemented as a generative model) of the robot may be able to ascertain the individual's personal preferences and bring back a beverage that the individual is more likely to enjoy.

Techniques described herein may give rise to various technical advantages. For example, techniques described herein may leverage new user interactions between a user and a client device to update a user's USCD, such as by adding new user attributes that, if accounted for when the individual engages with generative AI, would benefit the user's experience by making responses more useful and/or tailored to a user's specific situation. This in turn may decrease the interaction required, thereby reducing the use of computational resources such as memory and processor cycles.

Techniques described herein may also enable generative model input prompts (or context) to be shortened because the raw data that is used to formulate USCD may be compressed in various ways, such that the resulting USCD is more concise than the underlying raw data, or than what a user may provide as a manual prompt. For example, natural language describing aspects or attributes of a user, such as electronic correspondence, consumed documents, database tables, etc., may be condensed using techniques such as generative model-based textual summarization prior to being assembled into the USCD. Additionally or alternatively, the USCD could be formulated as reduced-dimensionality, semantically-rich embedding(s) that can be represented using far fewer input tokens than, for instance, natural language, database tables, logs of user queries, emails or other electronic correspondence in native formats, etc. Having concise USCD may decrease—potentially to a significant degree—the amount of calculations required to process the input prompts, thereby decreasing computational cost/load and/or latency experienced by the user.

### BRIEF DESCRIPTION OF THE DRAWINGS

FIG. 1 is a block diagram of an example environment in which implementations disclosed herein may be implemented.

FIG. 2 schematically depicts an example process flow that demonstrates various aspects of the present disclosure, in accordance with various implementations.

FIG. 3 schematically depicts an example process flow that demonstrates various aspects of the present disclosure, in accordance with various implementations.

FIG. 4 schematically depicts an example process for carrying out selected aspects of the present disclosure.

FIG. 5 illustrates an example architecture of a computing device.

### DETAILED DESCRIPTION

Implementations described herein relate to building and maintaining “user-specific conditioning data” in association with individual users, as well as using user-specific conditioning data in conjunction with generative artificial intelligence (AI) to generate content that is tailored to individual users. User-specific conditioning data (often abbreviated herein to “USCD”) may be built and/or maintained by accumulating and/or monitoring data derived from various types of user interactions with computing devices. These user interactions can include, for instance, users sending/receiving electronic correspondence such as emails or texts, users reconfiguring smart appliances (e.g., lights, thermostats, locks, televisions, speakers, blinds, garage door openers, etc.), users submitting search queries and/or consuming content responsive to search queries, user engagement with social media, users creating and/or consuming documents, and so forth. USCD itself may be expressed in various forms, such as a textual description/summary of the individual's attributes, tokens/embeddings encoding the individual's attributes, images and/or other modalities that convey the individual's attributes, or any combination thereof.

Various attributes of an individual, the computing devices and/or smart appliances they operate, and/or their lifestyle can change over time. These changes should be reflected in the individual's user-specific conditioning data. Accordingly, in various implementations, generative AI may be leveraged to, with the user's express permission, monitor and/or evaluate the user's interactions over time with various computing devices to detect when attributes of the individual and/or devices they operate change. Techniques described herein may then update the user-specific conditioning data accordingly. For example, with or without any explicit request by an individual (but with the individual's prior permission), the individual's user-specific conditioning data may be assembled into what will be referred to herein as an “USCD update prompt.” The USCD update prompt may be further assembled to include data indicative of one or more new user interactions, between the individual and computing device(s), that are newer or “fresher” than the individual's most recent user-specific conditioning data. Additionally, in some implementations, the USCD update prompt may be assembled to include a request to identify portion(s) of the user-specific input prompt that are out-of-date (or “stale”) in view of the one or more new user interactions.

This USCD update prompt may be processed using generative model(s) to create generative model output. In various implementations, the generative model output may identify portions of the user-specific conditioning data that are out-of-date/stale in view of the one or more new user interactions. For instance, the generative model output may include annotations identifying specific portions (e.g., sequences of tokens, passages of text, etc.) of the user-specific conditioning data that are out-of-date, and in some cases, mappings between those identified portions and the new user interaction(s) that rendered those identified portions stale. These new user interaction(s) may be referred to herein as “supplanting” user interactions, and portion(s) of the user-specific conditioning data they supplant may be referred to as “supplanted” portion(s).

In some implementations, data indicative of the identified stale portions of the user-specific conditioning data and the new user interactions that will supplant them may be assembled into another input prompt referred to herein as an “update prompt.” In some implementations, the entire user-specific conditioning data may be included in the update prompt, along with the annotations and/or mappings mentioned previously. In other implementations, only the state portions of the user-specific conditioning data may be included in the update prompt, to the exclusion of other portions of the user-specific conditioning data that remain “fresh” or “up-to-date.” This update prompt may also be assembled in some implementations to include a request to replace the stale portions with data indicative of the supplanting new user interactions.

The update prompt may then be processed using generative model(s) to generate new generative model output that includes, for instance, updated and/or replacement portion(s) or “version(s)” that can be used to update and/or replace the identified stale portion(s) of the user-specific conditioning data. These updated and/or replacement portion(s)/version(s), when combined with the rest of the user-specific conditioning data that remains fresh, may subsequently serve as new user-specific conditioning data for the individual.

New user interactions may take numerous forms, and may, when incorporated into user-specific conditioning data, condition generative model(s) in various ways. In some implementations, the data indicative of new user interaction(s) may include electronic correspondence (e.g., emails texts, direct messages) sent or received by the individual. For example, the individual may receive an email or notification indicating that an upcoming flight has been canceled. Techniques described herein may be used to update the individual's user-specific conditioning data to reflect that flight's cancellation (whereas prior to this update, the individual's user-specific conditioning data may have assumed the flight was still departing as scheduled). Consequently, when the individual issues a new generative model query relating to his or her upcoming schedule, that flight's cancellation will be reflected in the generative model's output.

Additionally or alternatively, the new user interaction(s) may include search engine queries formulated and/or submitted by or on behalf of the individual. For example, the individual may issue one or more search engine queries seeking recommendations for vegetarian restaurants suitable for “work gatherings.” Techniques described herein may update the individual's user-specific conditioning data to reflect the user's preference for vegetarian cuisine in relation to “work gatherings.”

In some implementations, the new user interaction(s) may include document(s) consumed by the user. For example, the user may read a technical manual explaining how a particular smart appliance is operated. Techniques described herein may update the individual's user-specific conditioning data to the individual's consumption of that technical manual. Consequently, when the individual issues a new generative model query relating to operating that smart appliance, content of that technical manual may be accounted for by the generative model, e.g., to condition the generative model output towards new information not contained in that technical manual.

In some implementations, the new user interaction(s) may include interactions that relate to commissioning a new smart appliance into a coordinated ecosystem of smart appliances associated with the user, altering a configuration of a smart appliance within the coordinated ecosystem, and/or decommissioning a smart appliance from the coordinated ecosystem. For example, an individual's household may initially include some number of smart appliances (e.g., lights, thermostats, blinds, locks, televisions, etc.), and these appliances'“configuration data” (e.g., any data usable to identify, access, interact with, and/or operate a smart appliance) may be incorporated into the individual's user-specific conditioning data, automatically and/or manually by the individual.

Suppose the individual replaces a first smart appliance in the ecosystem with a second smart appliance (e.g., replacing a smart light bulb). Data indicative of this user interaction may be assembled into an USCD update prompt, along with the individual's user-specific conditioning data. The USCD update prompt may be processed using generative model(s) to generate output identifying portion(s) of the user-specific conditioning data that are state or out-of-date in view of the new user interaction data. In this example, those identified stale portion(s) may include configuration data relating to the first smart appliance.

In various implementations, data indicative of the identified stale portion(s) may be assembled into an update prompt, along with data indicative of the new user interactions (commissioning the second smart appliance). This update prompt may be processed using generative model(s) to generate output that includes new versions of the identified stale portion(s) of the user-specific conditioning data. These new versions, along with portion(s) of the user-specific conditioning data that remain fresh without updating, may be used subsequently as updated user-specific conditioning data. Consequently, when the individual subsequently issues a generative model query that seeks to interact with the second smart appliance, the resulting generative model output may include commands or other data that is operable to interact with the second smart appliance.

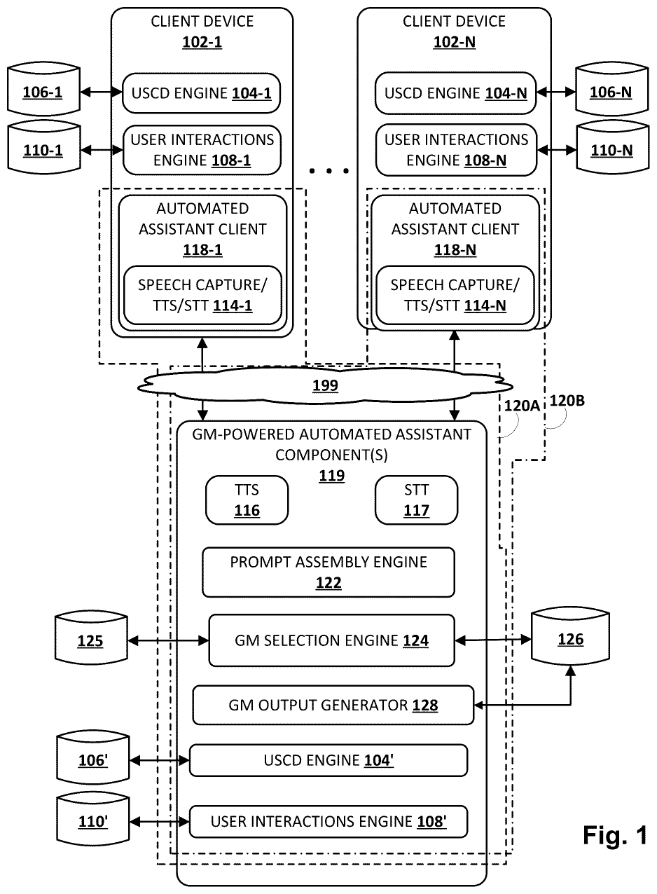

Now turning to FIG. 1, an example environment in which techniques disclosed herein may be implemented is illustrated. The example environment includes a plurality of client computing devices 102-1 to 102-N. Each client device 102 may execute a respective instance of an automated assistant client 118. One or more GM-powered automated assistant components 119 may be implemented on one or more computing systems/servers (collectively referred to as a “cloud” computing system) that are communicatively coupled to client devices 102-1 to 102-N via one or more local and/or wide area networks (e.g., the Internet) indicated generally at 199. Moreover, one or more GM-powered automated assistant components 119 might alternatively be implemented at one or more of client devices 102.

An instance of an automated assistant client 118, by way of its interactions with one or more GM-powered automated assistant components 119, may form what appears to be, from the user's perspective, a logical instance of an automated assistant 120 with which the user may engage in a human-to-computer dialog. Two instances of such an automated assistant 120A, 120B are depicted in FIG. 1 in dashed line. It thus should be understood that each user that engages with an automated assistant client 118 executing on a client device 102 may, in effect, engage with his or her own logical instance of an automated assistant 120. For the sake of brevity and simplicity, the term “automated assistant” as used herein as “serving” a particular user will refer to the combination of an automated assistant client 118 executing on a client device 102 operated by the user and one or more GM-powered automated assistant components 119. It should also be understood that in many cases, automated assistant 120 may respond to a request from any user regardless of whether the user is actually “served” by that particular instance of automated assistant 120.

The client devices 102 may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device), a robot, etc. Additional and/or alternative client computing devices may be provided.

In various implementations, an individual communicates with automated assistant 120 utilizing any one of a plurality of client computing devices that collectively form a coordinated ecosystem of client computing devices. In some cases, the coordinated ecosystem of client devices may be linked to the individual via a user profile of the individual that is associated with, for example, the individual's email address. In some such implementations, the individual's user-specific conditioning data (USCD) may also be linked with this same profile, so that that the individual's USCD may be used when the individual operates any client device of their coordinated ecosystem to interact with automated assistant 120, or more generally, to interact with generative model(s).

Automated assistant 120 engages in human-to-computer dialog sessions with a user via user interface input and output devices of one or more client devices 102-1 to 102-N. To preserve user privacy and/or to conserve resources, in many situations a user must often explicitly invoke the automated assistant 120 before the automated assistant will fully process a spoken utterance. The explicit invocation of the automated assistant 120 can occur in response to certain user interface input received at the client devices 102. For example, user interface inputs that can invoke the automated assistant 120 via the client devices 102 can optionally include actuations of a hardware and/or virtual button of the client device 102. In some implementations, the automated assistant client may include a component 114 that is configured to capture the user's utterance and either convert it to text using text to speech (TTS) processing, or in some cases, convert the audio directly into semantically rich embeddings, e.g., using an end-to-end transformer-based architecture (with text being generated, if at all, as a byproduct). The component 114 may also include speech to text (STT) functionality for converting text (or embeddings) to synthetic audio such as speech. For example, textual content received from GM-powered automated assistant components 119 may be processed using the STT functionality of component 114 and output as audio content using one or more speakers.

Client devices 102-1 to 102-N may also include user-specific conditioning data (USCD) engines 104-1 to 104-N and user interactions engines 108-1 to 108-N that are operably coupled, directly or indirectly, with user-specific conditioning (USCD) databases 106-1 to 106-N and user interactions databases 110-1 to 110-N, respectively. Additionally or alternatively, in some implementations, cloud-based instances of these components may be provided. For instance, there may be a cloud-based USCD engine 104′, a cloud-based USCD database 106′, a cloud-based user interactions engine 108', and/or a cloud-based user interactions database 110′. Anytime any of the reference numerals 104 to 110 are used herein without any additional context (e.g., “−1” or a single quote), that may refer to either the local instance (e.g., 104-1, 106-1, 108-1, 110-1) or the cloud-based instance (e.g., 104, 106, 108, 110).

USCD engine 104 may be configured to build and/or maintain USCD for each user based on data received from user interactions engine 108 and/or from other sources, such as automated assistant client 118. USCD may be indicative of a wide variety of an individual's attributes, including but not limited to preferences, observed behavior, content of electronic correspondence, smart appliance configurations, user-centric coordinated ecosystems of computing devices, schedules, travel history and/or any combination thereof. As noted elsewhere herein, individuals may have complete control over which user interactions (and hence, which of their attributes) are incorporated into their USCD, and which user interactions are not.

USCD engine 104 may store USCD in USCD database 106 in various forms and/or modalities, such as natural language text, structured text such as extensible markup language (XML) or JavaScript Object Notation (JSON), semantically-rich embeddings/tokens, images, videos, and/or any combination thereof. In various implementations, USCD engine 104 may represent user interactions in USCD in different ways. For example, USCD engine 104 may incorporate data indicative of new user interactions into USCD in raw form, whereas previous user interactions may be summarized in the USCD as text/embeddings. In some instances, those new user interactions may be subsequently summarized into text/embeddings when convenient/during downtime. In some implementations, USCD engine 104 or other components herein may formulate USCD to be condensed relative to raw data from which it is derived. For instance, electronic correspondence and/or textual documents consumed by an individual may be summarized using generative model(s) into abridged textual summaries and/or encoded into reduced-dimensionality embedding(s) before being stored as USCD in database 106.

In some implementations, USCD stored in USCD database 106 may be associated with various metadata. This metadata may include, for instance, mappings between portions of the USCD and the underlying user interactions (e.g., raw data) that spawned those portions of the USCD, which are described elsewhere herein. Additionally or alternatively, in some implementations, the metadata associated with USCD may include timestamps of when, for instance, those portions were added to the USCD or last modified. In some instances, these timestamps may be used as mappings between portion(s) of the USCD and an underlying user interactions timeline that is stored, for instance, in user interactions database 110. The USCD metadata may additionally or alternatively include confidence measures associated with individual pieces of data. For instance, a search engine query seeking vegetarian restaurants may be assigned less confidence than an explicit statement from an individual that he or she is a vegetarian. This may be because, for instance, the search engine query is capable of multiple interpretations, such as the individual was seeking a restaurant for a vegetarian friend or colleague. The explicit statement is less ambiguous, and therefore may be assigned a greater confidence measure.

In many implementations, USCD engine 104 may be required to solicit explicit and/or implicit permission from individuals prior to storing data received from user interactions engine 108 as part of USCD in USCD database 106. For example, USCD engine 104-1 may cause client device 102-1 to audibly and/or visually prompt the individual to expressly indicate their willingness to have data provided as USCD by USCD engine 104 and/or user interactions engine 108 be stored by USCD engine 104 in USCD database 106. By opting into such use of their personal data, the individual's privacy and/or security in using such data is maintained. Additionally or alternatively, in some implementations, an individual's USCD may be encrypted before being transmitted to GM-powered automated assistant components 119 and/or shared with other components, such as the cloud-based USCD engine 104′ and corresponding cloud-based USCD database 106′, or the cloud-based user interactions engine 108′ and corresponding cloud-based user interactions database 110′.

In various implementations, and with the individual's express permission, user interactions engine(s) 108 may be configured to monitor various types of user interactions between the individual and one or more computing devices 102-1 to 102-N, and store data indicative of relevant interactions in user interactions database 110. In other implementations, USCD engine(s) 104 may handle all functions attributed herein to user interactions engine(s) 108, and user interactions engine(s) 108 may be omitted.

As one example, user interactions engine 108 (or USCD engine 104 in some implementations) may monitor emails, text messages, and/or other forms of electronic content sent or received, e.g., via network 199, by user device 102-1. If the individual receives an email about a flight cancellation, user interactions engine 108 may store data indicative of this email in user interactions database 110. USCD engine 104 may use this data to update the individual's USCD in USCD database 106 to reflect the flight cancellation. Alternatively, USCD engine 104 may monitor emails and update USCD directly, and the user interactions engine 108 may be omitted. The flight cancellation might be used during a subsequent interaction between the individual and a generative model 126. For example, the individual might ask the automated assistant 120 “What is my travel schedule for next week?” The automated assistant 120, using generative model 126, would then be able to provide a more accurate and relevant response, taking into account the flight cancellation.

As another example, user interactions engine 108 (or USCD engine 104 in some implementations) may monitor search engine queries, search engine responses, automated assistant queries, automated assistant responses, and/or other forms of search results received, e.g., via network 199, by user device 102-1. As an example, if an individual searches for vegetarian restaurants, user interactions engine 108 may store data indicative of this query in user interactions database 110. USCD engine 104 may use data indicative of such a search query to update the individual's USCD in USCD database 106 to reflect the user's preference for vegetarian cuisine. The individual's preference for vegetarian cuisine, as it is reflected in the individual's USCD, might be used during a subsequent interaction between the individual and a generative model 126 by providing the individual with restaurant recommendations that are vegetarian-friendly. For example, if the individual asks, “What are some good restaurants near me?”, the generative model 126 could take into account the individual's preference for vegetarian cuisine and recommend restaurants that have a large selection of vegetarian dishes.

As yet another example, user interactions engine 108 (or USCD engine 104 in some implementations) may monitor content consumed, e.g., viewed, listened to, or otherwise experienced by a user device 102-1 to 102-N. For example, if a user watches an online video about a specific topic, user interactions engine 108 may store data indicative of this video in user interactions database 110. This data can then be used to update the user's USCD in USCD database 106 to reflect the user's interest in that topic. As another example, if a user listens to a podcast episode about a specific event, user interactions engine 108 (or USCD engine 104 in some implementations) may store data indicative of this podcast episode in user interactions database 110. USCD engine 104 may use this data to update the user's USCD in USCD database 106 to reflect the user's awareness of that event. If the user later asks the automated assistant 120 “What is the latest news about the event?”, the automated assistant will be able to provide more relevant information based on the user's awareness of the event from the podcast episode.

As yet another example, user interactions engine 108 (or USCD engine 104 in some implementations) may monitor user preferences and/or other user feedback explicitly submitted by the user, e.g., via automated assistant client 118 or otherwise. User preferences that might be captured and incorporated into the USCD include, but are not limited to, preferences for specific types of content (e.g., news, entertainment, music, etc.), preferences for specific topics or genres (e.g., sports, cooking, history, etc.), preferences for specific languages, preferences for specific styles or formats (e.g., formal, informal, casual, etc.), preferences for specific levels of detail or complexity, preferences for specific types of responses (e.g., factual, creative, humorous, etc.), preferences for specific sources of information, preferences for specific types of interactions (e.g., text-based, voice-based, visual, etc.), preferences for specific levels of personalization, preferences for specific levels of privacy, preferences for specific types of assistance (e.g., task-oriented, informational, conversational, etc.), preferences for specific time periods or contexts (e.g., work, home, travel, etc.), preferences for specific individuals or groups (e.g., family, friends, colleagues, etc.), and/or preferences for specific locations or settings.

As yet another example, user interactions engine 108 (or USCD engine 104 in some implementations) may monitor changes made to smart appliance configuration(s) by user device(s) 102-1 to 102-N. Suppose a user adds a new smart light to their kitchen. User interactions engine 108 may store data indicative of this change in user interactions database 110. This data can then be used to update the user's USCD in USCD database 106 to reflect the new configuration of the user's smart appliances. The user's new smart light in the kitchen would be reflected in the user's USCD. When the user asks the automated assistant to “turn on all the kitchen lights” the automated assistant will now include the new smart light in its response, turning it on along with the other lights. Changes made to smart appliance configurations can take a variety of different forms, including but not limited to adding, modifying, and/or removing a smart appliance, installing or removing a software application that interacts with the smart appliance (e.g., a security application, a smart home application, a “smart” thermostat application, etc.), modifying and/or adjusting settings and/or parameters of the smart appliance, modifying and/or adjusting settings and/or parameters of the software application that interacts with the smart appliance, etc.

As yet another example, user interactions engine 108 (or USCD engine 104 in some implementations) may monitor locations and/or trajectories of locations accumulated with prior user consent by one or more client devices 102-1 to 102-N. For example, if an individual frequently visits a particular neighborhood, their USCD may include a record of these visits. If the individual later asks the automated assistant 120, “I want to try something new,” the automated assistant could use the individual's location history to suggest locations outside of their usual neighborhood. If the individual later decides to opt out of having their locations tracked, accumulated locations may be deleted from the individual's user interactions database 110. This may trigger implementations described herein to follow mappings from those deleted trajectories to the individual's USCD, where corresponding portion(s) of the USCD can likewise be deleted. Consequently, if the individual later asks the automated assistant 120, “I want to try something new,” the individual's past travels will no longer be accounted for in the generative model response.

Similar to USCD engine 104, in various implementations, user interactions engine 108 may be required to solicit explicit and/or implicit permission from an individual prior to monitoring user interaction(s) between the individual and computing devices 102-1 to 102-N and storing data indicative thereof in user interactions database 110. For example, user interactions engine 108 may cause client device 102-1 to audibly and/or visually prompt the individual to expressly indicate their willingness to have data provided as user interaction(s) by user interactions engine 108 be stored in user interactions database 110. By being able to opt in and/or out of such use of their personal data, the individual's privacy and/or security in using such data is maintained. In some implementations, an individual's user interaction(s) may be stored only in local user interactions database 110, or may be encrypted before being transmitted to GM-powered automated assistant components 119 and/or shared with other components.

GM-powered automated assistant component(s) 119 may include a TTS component 116, an STT component 117, a prompt assembly engine 122, a GM selection engine 124, a classifier 125, a GM output generator 128, a cloud-based USCD engine 104′and corresponding database 106′, and a cloud-based user interactions engine 108′ and corresponding user interactions database 110′. TTS component 116 may be configured to leverage the virtually limitless resources of the cloud computing system to convert textual data (e.g., natural language responses formulated by automated assistant 120) into computer generated speech output. In some implementations, TTS component 116 may provide the computer generated speech output to client device 102 to be output directly, e.g., using one or more speakers. TTS component 116 may use any appropriate speech synthesis technique to generate computer generated speech output from textual data including, but not limited to, concatenative synthesis, unit selection synthesis, diphone synthesis, domain-specific synthesis, formant synthesis, Hidden Markov Model (HMM)-based synthesis (e.g., Gaussian mixture core network synthesis), sinewave synthesis, or any combination thereof. In some implementations, the TTS component 116 may be implemented using an end-to-end transformer-based architecture.

STT component 117 may be configured to convert a spoken utterance into text data. In some implementations, STT component 117 may convert an utterance into multiple text segments, e.g., phonemes, word pieces, etc., that are strings of characters corresponding to the utterance. STT component 117 may convert the utterance into text data using various speech recognition techniques, such as hidden Markov model (HMM) techniques, dynamic time warping (DTW)-based techniques, neural network-based techniques, or other techniques. In some implementations, the STT component 117 may be implemented using an end-to-end transformer-based architecture.

Prompt assembly engine 122 may be configured to assemble generative model prompts (or “context”) that can then be used by GM selection engine 124 to select one or more GMs from GM database 126, and that can be used by GM output generator 128 to generate generative model output. Prompt assembly engine 122 may assemble generative model prompts from various data sources, such as a user's explicit or implicit generative model query. An explicit generative model query may be issued via the user typing or speaking the query. An implicit generative model query may be issued automatically, e.g., in response to various events that may occur in a software application, in response to particular sensor data, etc.

In addition to an individual's explicit or implicit generative model query, prompt assembly engine 122 may assemble other data into a generative model prompt. For example, prompt assembly engine 122 may assemble data indicative of the individual's USCD, received from cloud-based USCD engine 104′or a local USCD engine 104-1 to 104-N into the generative model prompt. In some implementations, a cloud-based USCD engine 104′ may obtain this USCD from database 106-1 of client device 102-1 and may temporarily store it in a cloud-based USCD database 106′. Additionally or alternatively, cloud-based USCD engine 104′ may store individuals'USCD data in cloud-based USCD database 106′ on a long term basis, while taking steps to ensure the privacy and security of the individuals'USCD. In some such implementations, the individuals may be required to provide express permission before their USCD can be stored in cloud-based USCD database 106′. Additionally or alternatively, in some implementations, USCD stored in database 106′ (or locally at 106) may be stored in a form that is not readily interpretable by humans, such as in continuous embedding form, encrypted form, hashed form, etc.

As noted above, GM selection engine 124 may be configured to select one or more generative models 126 that are suitable for generating content responsive to, for instance, an individual's generative model query (or even to a generic search query), to an implicit query, and/or to a request to update an individual's USCD based on new user interaction(s). In some implementations, GM selection engine 124 may utilize a classifier 125 to identify a generative model that is most likely to accurately and efficiently respond to a generative model query provided by automated assistant 120 and an individual that provided the generative model query. Such a classifier may itself be a generative model (e.g., an LLM), or it may be another type of machine learning model that is trained to classify or otherwise generate scores for different available generative models 126. As one example, if an individual's query includes both text and an image (e.g., “modify this image to delete the clouds”), the GM selection engine 124 may select a generative model that is suitable for generating synthetic image data, such as a diffusion model. Additionally or alternatively, GM output generator 128 may include a plurality of generative model agents, each configured to perform different task(s) using different generative models, and the GM selection engine 124 may select the most suitable GM agent.

GM output generator 128 may be configured to process a prompt using one or more generative models selected by GM selection engine 124 from GM database 126 (GM database and generative models themselves will both be interchangeably referenced using 126) to generate content that is responsive to, for instance, a generative model query from automated assistant client 118 at a client device 102, or to an implicit query to update an individual's USCD based on new user interaction(s). To this end, GM output generator 128 may have access to one or more generative models in database 126, and may apply those generative model(s) that are selected by GM selection engine 124.

GM database 126 may include a variety of generative models, such as foundation models, fine-tuned models, and task-specific models. Foundation models may be pretrained on large datasets of various types of data, such as text, code, images, videos, audio, etc. Foundation models can be used for a wide range of tasks. Fine-tuned models are foundation models that have been further trained on a specific dataset, such as a dataset of customer service conversations or a dataset of medical records. Task-specific models are designed for a specific task, such as generating code, translating languages, or writing different kinds of creative content. Generative models can be single-modal or multi-modal. Single-modal models process and generate data of a single type, such as text or images. Multi-modal models process and/or generate data of multiple types, such as text and images, or text and audio. Generative models may or may not be transformer-based, and may be encoder-only, decoder-only, or encoder-decoder. Encoder-only models take an input and produce a representation of that input. Decoder-only models take a representation and produce an output. Encoder-decoder models combine both encoder and decoder components. Some generative models that generate non-textual data may include, for instance, stable diffusion models.

The number of parameters in a generative model can vary significantly depending on the model's complexity and the resources available for its implementation. On a resource-constrained client device like 102, the model may have a smaller number of parameters to optimize performance and reduce memory usage. This is because client devices often have limited processing power and memory compared to cloud servers. In contrast, a generative model implemented on a cloud server like 119 can have a much larger number of parameters due to the availability of extensive computing resources. This allows for more complex models with higher accuracy and capabilities. The choice of parameter size is a trade-off between model performance and resource constraints. For example, on a client device with limited resources, a generative model might have 100 million parameters, while a server-based model could have billions of parameters, enabling more complex and accurate results. Another example is a client device model with 500 million parameters, compared to a server model with 100 billion parameters, showcasing the significant difference in scale and capabilities.

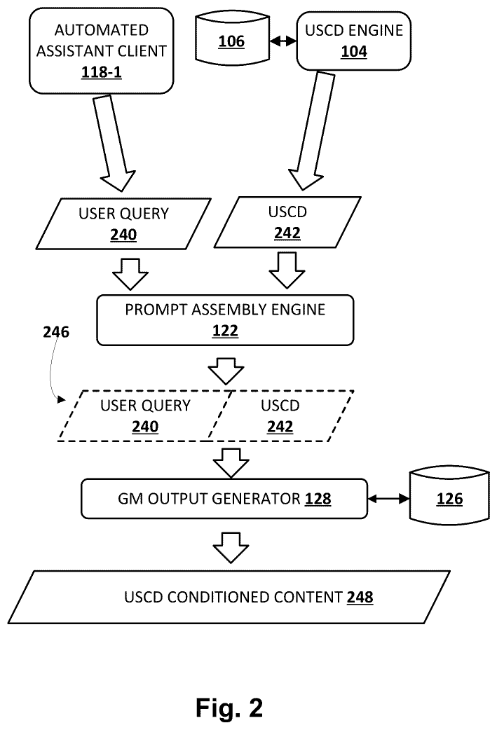

FIG. 2 schematically depicts an example of how various components of FIG. 1 may cooperate to conduct selected aspects of the present disclosure. Beginning at top, USCD engine 104 and automated assistant client 118-1 of client device 102-1 may provide, respectively, data indicative of a user-specific conditioning data (USCD) 232 and a user query 230 to prompt assembly engine 122. Prompt assembly engine 122 may then assemble the USCD 232 and the user query 230 into a generative model prompt 234. While not shown in FIG. 2 for the sake of brevity and simplicity, this generative model prompt 234 may be provided to GM selection engine 124, and GM selection engine 124 may select appropriate generative model(s) 126 and/or GM agents for processing this generative model prompt 234.

Moreover, various other information may or may not be assembled into generative model prompt 234 by prompt assembly engine 122. This other information may, for instance, identify tools (e.g., installed application, web applications (RESTful or RPC)) that are available to perform various functions (e.g., controlling smart appliances at a home or in a vehicle). Additionally or alternatively, this other information may include system instructions (e.g., not provided by the user) on how USCD should be used to personalize or otherwise condition the generative model output. For instance, the system instructions may include a natural language statement such as “When responding to the user's query, make sure to take into account this summary of the user, including the user's preferences, attributes, etc.” In some implementations, the system instructions may include additional requests designed to avoid various negative outcomes. For example, the system instructions may include a request such as “Medical data of the user should not be disclosed to anyone other than the user. Accordingly, don't directly incorporate the user's medical data into your response. At most, allow the user's medical data to influence other output you generate, without explicitly mentioning the medical data itself.”

Referring back to FIG. 2, prompt assembly engine 122 (or GM selection engine 124) may provide generative model prompt 234 to GM output generator 128. GM output generator 128 may then input the generative model prompt 234 into one or more generative models of GM database 126 to generate output that includes USCD-conditioned content 236. USCD conditioned content 236 may include content that is both responsive to user query 230 and conditioned upon USCD 232.

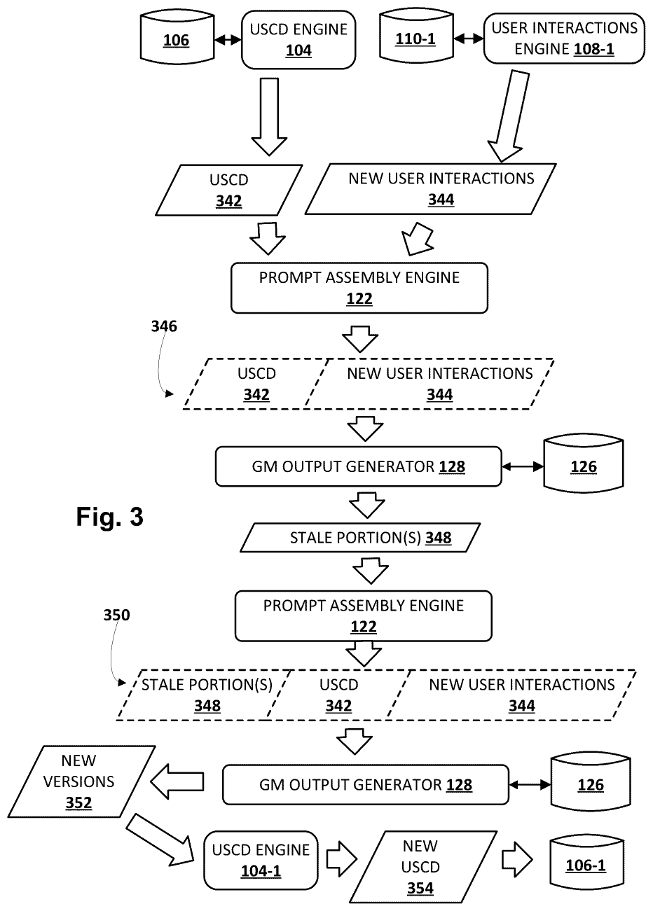

FIG. 3 schematically depicts an example of how various components of FIG. 1 may cooperate to carry out selected aspects of the present disclosure. Some of FIG. 3 is similar to what is depicted in FIG. 2. Accordingly, similar reference numerals are used, except beginning with a “3” instead of a “2.”

Beginning at top, USCD engine 104 and user interactions engine 108-1 of client device 102-1 may provide, respectively, data indicative of USCD 342 and one or more new user interactions 344 to prompt assembly engine 122. Prompt assembly engine 122 may then assemble the USCD 342 and the one or more new user interactions 344 into a generative model prompt 346. While not shown in FIG. 3 for the sake of brevity and simplicity, this generative model prompt 346 may be provided to GM selection engine 124, and GM selection engine 124 may select appropriate generative model(s) for processing this generative model prompt 346.

Referring back to FIG. 3, prompt assembly engine 122 (or GM selection engine 124) may provide generative model prompt 346 to GM output generator 128. GM output generator 128 may process generative model prompt 346 to generate output that includes or otherwise identifies stale portion(s) 348 USCD 342 that are out-of-date in view of the one or more new user interactions 344. Stated alternatively, stale portion(s) 348 may be identified by GM output generator 128 as one or more portions of USCD 342 that are no longer representative of the user. Stale portion(s) 348 may be represented in various ways, such as with annotations, mappings, and/or other metadata.

In various implementations, mappings may identify specific portions of USCD 342 that are stale, and in some cases, new user interaction(s) 344 that will be used to supplant/replace/update those stale portions of USCD 342. Suppose USCD 342 takes the form of natural language text (e.g., a natural language summary of a user's preferences, attributes, history, etc.). The mappings may include pointers or other annotations that identify relationships or pairings between textual snippets of USCD 342 and particular portions of new user interactions 344, e.g., by identifying parts of user interactions 344, such as locations in memory, delimiting characters, keywords or phrases, segments of text, ranges of tokens and/or embeddings, etc.

As one example, when a user who needs to replace their roof initially issues the search query “find me a good roofer who specializes in terracotta-clay tiles,” data indicative of that query (“seeking terracotta-clay roof”) may be stored by user interactions engine 108-1 in user interactions database 110-1. A corresponding portion may be added by USCD engine 104-1 to the user's USCD 342 in USCD database 106-1 to include the data indicative of that query. However, upon determining that terracotta-clay roofs are cost-prohibitive, the user may issue a subsequent query, “find me a good roofer who specializes in metal roofs.” When the user's subsequent search query is processed as described herein, the portion of the user's USCD 342 corresponding to the terracotta-tile roof may be flagged as stale, and a mapping may be created between that portion (e.g., a textual snippet, sequence of tokens, embedding(s), etc.) and the new user interaction data indicative of the user's subsequent query about metal roofs. This mapping may then be used, e.g., by USCD engine 104-1, to access the stale portion of USCD 342, update its data to reflect the user's most recent query (from “terra-cotta tiles” to “metal”), and provide updated USCD data to USCD database 106.

Referring back to FIG. 3, in various implementations, prompt assembly engine 122 may then assemble, as an update prompt 350, data indicative of the identified stale portion(s) 348 and data indicative of the new user(s) interactions 344. In some implementations, prompt assembly engine 122 may further assemble update prompt 350 to also include all of USCD 342, and/or only stale portion(s) 348, to the exclusion of other portion(s) of USCD 342 that remain fresh/up-to-date.

Once update prompt 350 is assembled, it may be provided to GM output generator 128. GM output generator 128 may process update prompt 350 to generate new version(s) 352 of stale portion(s) 348 of USCD 342. These new versions 352 of the stale portion(s) 348 may then be added, e.g., by USCD engine 104-1 (or cloud-based USCD engine 104′), to USCD 342 in place of stale portion(s) 348 to form new USCD 354. New USCD 354 may then be stored, e.g., by USCD engine 104-1, in USCD database 106-1 for subsequent use when the user submits a new generative model query to automated assistant 120.

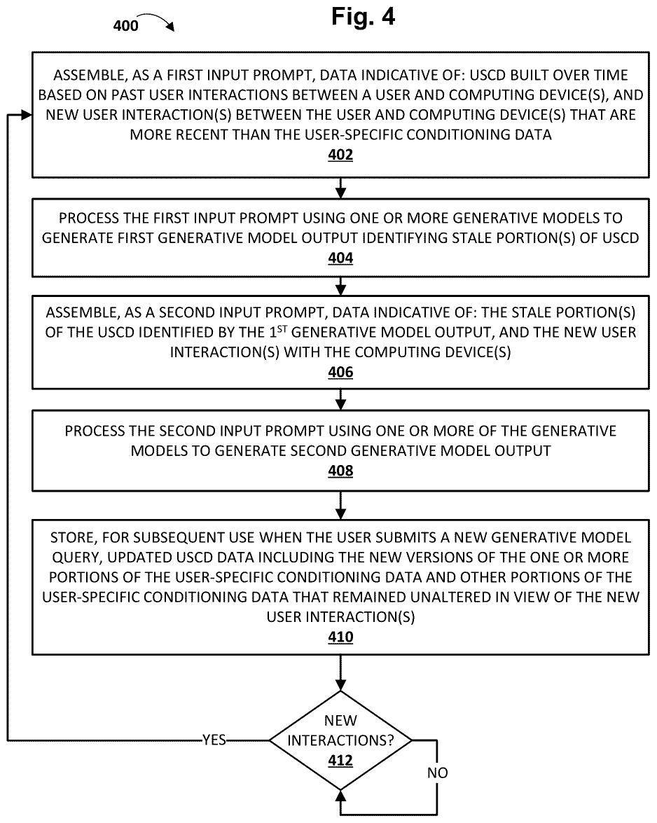

FIG. 4 depicts a flowchart illustrating an example method according to implementations disclosed herein. For convenience, the operations of the flow chart are described with reference to a system that performs the operations. This system may include various components of various computer systems, such as GM-powered automated assistant components 119 of FIG. 1 and/or of client devices 102-1 to 102-N. Moreover, while operations of the method of FIG. 4 are shown in a particular order, this is not meant to be limiting. One or more operations may be reordered, omitted, and/or added.

At block 402, the system, e.g., by way of prompt assembly engine 122, may assemble, as a first input prompt 346 (alternatively referred to herein as the “USCD update prompt”), data indicative of: USCD 342 built over time based on past user interactions between a user and one or more computing devices, and new user interaction(s) 344 between the user and one or more of the computing devices (e.g., 102) that are more recent than the USCD 342. The data indicative of the USCD 342 may be provided by the USCD engine 104 hosted locally on the respective client device 102 or by cloud-based USCD engine 104′. The data indicative of the new user interaction(s) 344 may be provided by user interactions engine 108 on client device or, if the user has provided express permission for data indicative of their user actions to be collected at the cloud, the data indicative of the new user interaction(s) may be provided by a cloud-based user interactions engine (not depicted in FIG. 1).

At block 404, the system, e.g., by way of GM output generator 128, may process the first input prompt 346 using one or more generative models to generate first generative model output. The first generative model output may identify one or more portions 348 of the user-specific conditioning data that are stale in view of the new user interaction(s) 344. For example, the first generative model output may include annotations identifying stale portion(s) 348 of USCD 342, and in some cases, mappings between those stale portion(s) 348 of USCD 232 and the new user interaction(s) 344 that caused them to be flagged (e.g., that negate, update, and/or supplant them).

At block 406, the system, e.g., by way of prompt assembly engine 122, may assemble, as a second input prompt 350 (alternatively referred to herein as the “update prompt”), data indicative of: the one or more stale portions 348 of the USCD 342 identified by the first generative model output, and one or more of the new user interactions 344 with one or more of the computing devices (e.g., 102). In some implementations, the entire USCD 232 may be assembled into the second prompt 250, e.g., along with mappings or annotations identifying those stale portions to be replaced. In other implementations, only the stale portions of USCD 232 are assembled by prompt assembly engine 122 into the second input prompt 250, e.g., to the exclusion of other portion(s) of USCD 232 that remain fresh/up-to-date.

At block 408, the system, e.g., by way of GM output generator 128, may process the second input prompt 350 using one or more generative models 126 to generate second generative model output, which may include new version(s) 352 of the one or more portions of USCD 342 that were identified as stale by the first generative model output. These new versions 352 of the stale portion(s) 348 may then be added, e.g., by the USCD engine 104 or USCD engine 104′, to USCD 342 in place of stale portion(s) 348 to form new USCD 354.

At block 410, new USCD 354 may be stored, e.g., by the USCD engine 104 or USCD engine 104′, in USCD database 106 for subsequent use when the user submits a new generative model query to automated assistant 120. Method 400 may then proceed to block 412. At block 412, the system, e.g., by way of user interactions engine 108, may monitor one or more additional user interactions 344 between the user and the one or more computing devices (e.g., 102) to determine whether there have been new interactions that might warrant updating the user's USCD 232. If the answer is yes, then method 400 may proceed back to block 402 and repeat. Otherwise, the system may periodically check for new interactions at block 412 until one or more new interactions are detected.

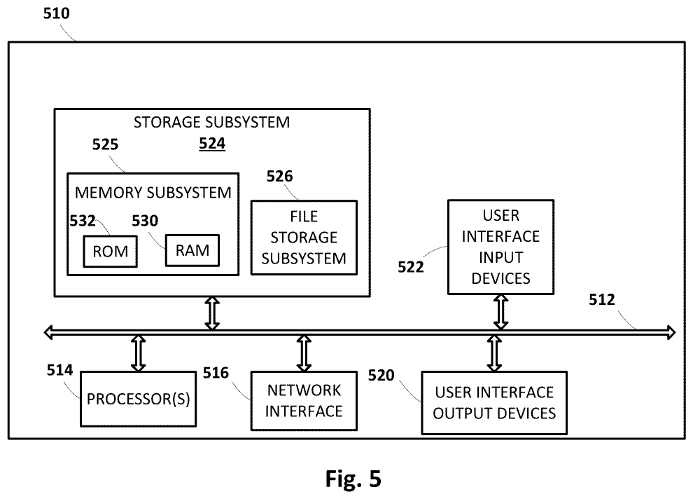

FIG. 5 is a block diagram of an example computer system 510. Computer system 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computer system 510. Network interface subsystem 516 provides an interface to outside networks and is coupled to corresponding interface devices in other computer systems.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 510 to the user or to another machine or computer system.

Storage subsystem 524 stores programming and data constructs that provide the functionality of some or all of the modules described herein. For example, the storage subsystem 524 may include the logic to perform selected aspects of method 400 of FIG. 4.

These software modules are generally executed by processor 514 alone or in combination with other processors. As used herein processors (including 514) may take various forms, such as one or more digital signal processors (DSPs), general purpose microprocessors, application specific integrated circuits (ASICs), field programmable gate arrays (FPGAs), or other equivalent integrated or discrete logic circuitry. Processor 514 can take the form of a central processing unit (CPU), a tensor processing unit (TPU), a neural processing unit (NPU), a graphics processing unit (GPU), or any other suitable processing unit.

Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computer system 510 communicate with each other as intended. Although bus subsystem 512 is shown schematically as a single bus, alternative implementations of the bus subsystem may use multiple buses.

Computer system 510 can be of varying types including a workstation, server, computing cluster, blade server, server farm, or any other data processing system or computing device. Due to the ever-changing nature of computers and networks, the description of computer system 510 depicted in FIG. 5 is intended only as a specific example for purposes of illustrating some implementations. Many other configurations of computer system 510 are possible having more or fewer components than the computer system depicted in FIG. 5.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. Moreover, features described herein may be activated, deactivated, and reactivated at the individual's discretion.

A method implemented using one or more processors may include assembling a first input prompt. This prompt may include data indicative of a user-specific conditioning data, which may be built over time based on past user interactions between a user and one or more computing devices. The prompt may also include data indicative of one or more new user interactions between the user and one or more of the computing devices that are more recent than the user-specific conditioning data. The first input prompt may then be processed using one or more generative models to generate first generative model output. This output may identify one or more portions of the user-specific conditioning data that are out-of-date in view of the one or more new user interactions.

In various implementations, a second input prompt may be assembled. This prompt may include data indicative of the one or more identified portions of the user-specific conditioning data, as well as data indicative of one or more of the new user interactions with one or more of the computing devices. The second input prompt may then be processed using one or more of the generative models to generate second generative model output. This output may include new versions of the one or more identified portions of the user-specific conditioning data.

An updated user-specific conditioning data may be stored for subsequent use when the user submits a new generative model query. This updated data may include the new versions of the one or more identified portions of the user-specific conditioning data, as well as other portions of the user-specific conditioning data that remained unaltered in view of the one or more new user interactions between the user and one or more of the computing devices.

In various implementations, the one or more new user interactions may include one or more new emails sent or received by the user. Alternatively, the one or more new user interactions may include one or more new search engine queries formulated and/or submitted by or on behalf of the user. The one or more new user interactions may also include one or more documents consumed by the user.

The one or more new user interactions may further include one or more digital images captured or altered by the user, one or more content purchases by the user, or one or more preferences provided explicitly by the user. The one or more new user interactions may also include rejection of generative model output provided to the user based on the user-specific conditioning data, or one or more social media posts of the user.

In various implementations, the one or more new user interactions may include one or more location trajectories accumulated by one or more of the computing devices, or one or more readings from one or more physiological sensors worn by the user. The one or more new user interactions may also include one or more of: commissioning a new smart appliance into a coordinated ecosystem of smart appliances associated with the user; altering a configuration of a smart appliance within the coordinated ecosystem; or decommissioning a smart appliance from the coordinated ecosystem.

In various implementations, the method may further include assembling a third input prompt. This prompt may include data indicative of the updated user-specific conditioning data, as well as a user-formulated generative model query. The third input prompt may be processed using one or more of the generative models to generate third generative model output. This output may include content that is responsive to the user-formulated generative model query and is conditioned based on the updated user-specific conditioning data. The method may then cause one or more output devices to render at least some of the responsive content.

In various implementations, the user-specific conditioning data may include mappings from particular portions of the user-specific conditioning data to past user interaction data that spawned the particular portions of the user-specific conditioning data.

Other implementations may include a transitory or non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
assembling, as a first input prompt, data indicative of:
a user-specific conditioning data, wherein the user-specific conditioning data was built over time based on past user interactions between a user and one or more computing devices; and
one or more new user interactions between the user and one or more of the computing devices that are more recent than the user-specific conditioning data;
processing the first input prompt using one or more generative models to generate first generative model output, wherein the first generative model output identifies one or more portions of the user-specific conditioning data that are out-of-date in view of the one or more new user interactions;
assembling, as a second input prompt, data indicative of:
the one or more identified portions of the user-specific conditioning data; and
one or more of the new user interactions with one or more of the computing devices;
processing the second input prompt using one or more of the generative models to generate second generative model output, wherein the second generative model output comprises new versions of the one or more identified portions of the user-specific conditioning data; and
storing, for subsequent use when the user submits a new generative model query, an updated user-specific conditioning data that includes the new versions of the one or more identified portions of the user-specific conditioning data and other portions of the user-specific conditioning data that remained unaltered in view of the one or more new user interactions between the user and one or more of the computing devices.

2. The method of claim 1, wherein the one or more new user interactions comprise one or more new emails sent or received by the user.

3. The method of claim 1, wherein the one or more new user interactions comprise one or more new search engine queries formulated and/or submitted by or on behalf of the user.

4. The method of claim 1, wherein the one or more new user interactions comprise one or more documents consumed by the user.

5. The method of claim 1, wherein the one or more new user interactions comprise one or more digital images captured or altered by the user.

6. The method of claim 1, wherein the one or more new user interactions comprise one or more content purchases by the user.

7. The method of claim 1, wherein the one or more new user interactions comprise one or more preferences provided explicitly by the user.

8. The method of claim 1, wherein the one or more new user interactions comprise:
rejection of generative model output provided to the user based on the user-specific conditioning data.

9. The method of claim 1, wherein the one or more new user interactions comprise one or more social media posts of the user.

10. The method of claim 1, wherein the one or more new user interactions comprise one or more location trajectories accumulated by one or more of the computing devices.

11. The method of claim 1, wherein the one or more new user interactions comprise one or more readings from one or more physiological sensors worn by the user.

12. The method of claim 1, wherein the one or more new user interactions comprise one or more of:
commissioning a new smart appliance into a coordinated ecosystem of smart appliances associated with the user;
altering a configuration of a smart appliance within the coordinated ecosystem; or
decommissioning a smart appliance from the coordinated ecosystem.

13. The method of claim 1, further comprising:
assembling, as a third input prompt, data indicative of:
the updated user-specific conditioning data; and
a user-formulated generative model query;
processing the third input prompt using one or more of the generative models to generate third generative model output, wherein the third generative model output comprises content that is responsive to the user-formulated generative model query and is conditioned based on the updated user-specific conditioning data; and
causing one or more output devices to render at least some of the responsive content.

14. The method of claim 1, wherein the user-specific conditioning data comprises mappings from particular portions of the user-specific conditioning data to past user interaction data that spawned the particular portions of the user-specific conditioning data.

15. A system comprising one or more processors and memory storing instructions that, in response to execution of the instructions by the one or more processors, cause the one or more processors to:
assemble, as a first input prompt, data indicative of:
a user-specific conditioning data, wherein the user-specific conditioning data was built over time based on past user interactions between a user one or more computing devices; and
one or more new user interactions between the user and one or more of the computing devices that are more recent than the user-specific conditioning data;
process the first input prompt using one or more generative models to generate first generative model output, wherein the first generative model output identifies one or more portions of the user-specific conditioning data that are out-of-date in view of the one or more new user interactions;
assemble, as a second input prompt, data indicative of:
the one or more identified portions of the user-specific conditioning data; and
one or more of the new user interactions with one or more of the computing devices;
process the second input prompt using one or more of the generative models to generate second generative model output, wherein the second generative model output comprises new versions of the one or more identified portions of the user-specific conditioning data;
store, for subsequent use when the user submits a new generative model query, an updated user-specific conditioning data that includes the new versions of the one or more identified portions of the user-specific conditioning data and other portions of the user-specific conditioning data that remained unaltered in view of the one or more new user interactions between the user and one or more of the computing devices.

16. The system of claim 15, wherein the one or more new user interactions comprise one or more new emails sent or received by the user.

17. The system of claim 15, wherein the one or more new user interactions comprise one or more new search engine queries formulated and/or submitted by or on behalf of the user.

18. The system of claim 15, wherein the one or more new user interactions comprise one or more documents consumed by the user.

19. A non-transitory computer-readable medium comprising instructions that, in response to execution of the instructions by one or more processors, cause the one or more processors to perform the following operations:
assembling, as a first input prompt, data indicative of:
a user-specific conditioning data, wherein the user-specific conditioning data was built over time based on past user interactions between a user one or more computing devices; and
one or more new user interactions between the user and one or more of the computing devices that are more recent than the user-specific conditioning data;
processing the first input prompt using one or more generative models to generate first generative model output, wherein the first generative model output identifies one or more portions of the user-specific conditioning data that are out-of-date in view of the one or more new user interactions;
assembling, as a second input prompt, data indicative of:
the one or more identified portions of the user-specific conditioning data; and
one or more of the new user interactions with one or more of the computing devices;
processing the second input prompt using one or more of the generative models to generate second generative model output, wherein the second generative model output comprises new versions of the one or more identified portions of the user-specific conditioning data;
storing, for subsequent use when the user submits a new generative model query, an updated user-specific conditioning data that includes the new versions of the one or more identified portions of the user-specific conditioning data and other portions of the user-specific conditioning data that remained unaltered in view of the one or more new user interactions between the user and one or more of the computing devices.

20. The non-transitory computer-readable medium of claim 19, wherein the one or more new user interactions comprise one or more of the following types:
one or more new emails sent or received by the user;
one or more new search engine queries formulated and/or submitted by or on behalf of the user;
one or more documents consumed by the user;
one or more digital images captured or altered by the user;
one or more content purchases by the user;
one or more preferences provided explicitly by the user;
one or more social media posts of the user;
one or more location trajectories accumulated by one or more of the computing devices;
one or more readings from one or more physiological sensors worn by the user;
commissioning a new smart appliance into a coordinated ecosystem of smart appliances associated with the user;
altering a configuration of a smart appliance within the coordinated ecosystem; or
decommissioning a smart appliance from the coordinated ecosystem.
